(19) United States
(12) Patent Application Publication
(10) Pub. No.: US 2013/0260351 A1
(43) Pub. Date: Oct. 3, 2013

(54) CALENDAR-DRIVEN SEQUENCING OF ACADEMIC LESSONS

(71) Applicant: DREAMBOX LEARNING INC., Bellevue, WA (US)

(72) Inventors: Lorenzo Pasqualis, Bellevue, WA (US); Nigel Green, Bellevue, WA (US); Daniel Kerns, Bellevue, WA (US)

(21) Appl. No.: 13/853,677

(22) Filed: Mar. 29, 2013

Related U.S. Application Data
(60) Provisional application No. 61/617,618, filed on Mar. 29, 2012.

(51) Int. Cl. G09B 5/00

(52) U.S. Cl. CPC G09B 5/00
USPC 434/322

(57) ABSTRACT

A system that delivers a sequence of learning objectives to a student in accordance with one or more target dates. The target dates may be set by an academic institution, a teacher, or a parent of the student. The system adjusts the sequence of learning objectives based on the target dates assigned to one or more of the learning objectives. The system estimates how long it will take for the student to progress through a sequence of learning objectives and notifies an administrator if the student is behind schedule. The notification to the administrator may include recommendations for remedial actions.

### CROSS-REFERENCE TO RELATED APPLICATION(S)

This application claims the benefit of U.S. Provisional Patent Application No. 61/617,618, entitled “CALENDAR DRIVEN SEQUENCING OF ACADEMIC LESSONS,” filed Mar. 29, 2012, which is incorporated herein by reference in its entirety.

### BACKGROUND

Schools and parents may use computerized educational systems to supplement in-person instruction provided to a student. The educational systems may provide various concepts to the student in an organized manner. The organization of the concepts may be based on a subject that the student is struggling with, or may be based on a subject in which the student has a particular interest. Typically, the presentation by the computerized educational system is linear and fixed in structure. A need exists for an educational system that improves the organization or sequence by which concepts are presented to a student.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 shows a high-level block diagram of an educational system, in accordance with one embodiment of invention.

FIGS. 2-7 show graphs of standards and particular sequencing paths taken through the graphs.

FIGS. 8A-8D are screenshots of a representative graphical user interface that is generated by the educational system.

FIG. 9 shows a high-level block diagram of representative hardware that may be used to implement the educational system.

### DETAILED DESCRIPTION

A computerized educational system that presents learning objectives to a student in a sequence intended to be completed by a desired target date set by an academic institution, corporation, or other organization is disclosed herein. The learning objectives may be defined as standards that the student should attain, skills that the student should learn, and/or lessons that are to be presented to a student. The educational system maintains a hierarchical organization of the learning objectives, such that predecessor learning objectives are linked to successor learning objectives. The organization of the learning objectives may be dictated by, for example, educational standards defined by a country, a state, or an academic institution. The educational system presents the learning objectives to the student so that broader (prerequisite) subject matter is presented before more specific subject matter. In other words, the educational system provides the student with prerequisite subject matter before providing subject matter that depends on the prerequisite subject matter. When a system operator, such as an academic institution, teacher, or parent sets a target date or range of dates by which time the student is to have achieved a particular learning objective (i.e., a target learning objective), the educational system adjusts the sequence of learning objectives to guide a student along a critical path or an optimal path to the target learning objective within the specified period.

In some embodiments, the educational system determines the critical path or optimal path for the student by calculating how much time the student has to study before the target date, calculating how much time it will take the student to complete the learning objectives along the determined path, and comparing the amount of time the student has to study with the amount of time it will take the student to complete the learning objectives. If the time it will take for the student to complete the learning objectives exceeds the amount of time the student has to work on the learning objectives, the educational system notifies a system operator or other individual that the student may not reach or complete the target learning objective by the target date or dates. The educational system may then recommend one or more remedial actions for the educator or institution to take. In some implementations, the educational system will provide an educator or administrator with an amount of time the student needs to increase his or her studies in order to achieve the learning objective. In other implementations, the educational system will notify the educator or administrator of a particular subject the student appears to be having difficulty with, thereby allowing the educator or administrator to focus extra resources on that particular subject.

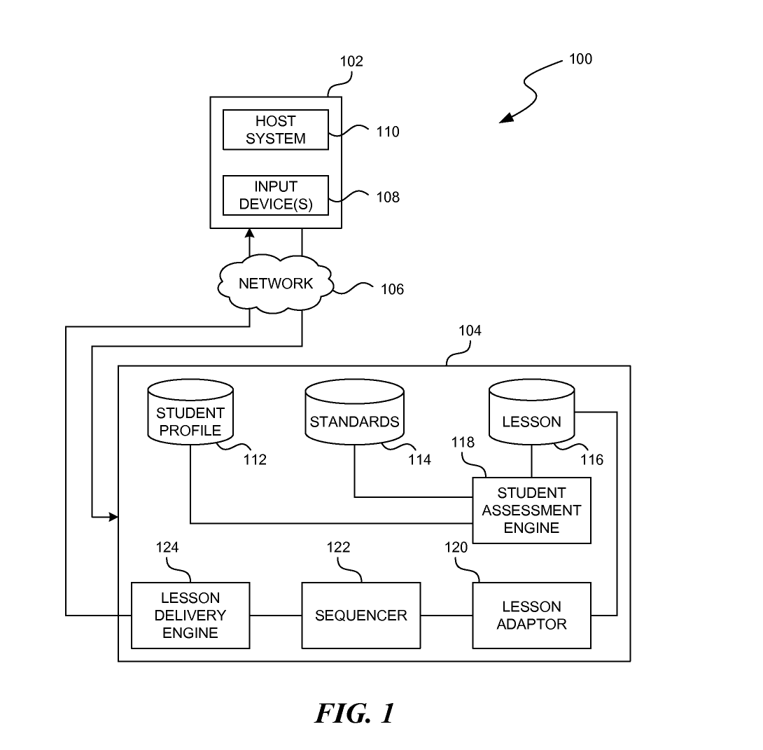

The educational system provides several advantages to system users, whether administrator, educator, student, or other interested party. While providing learning objectives to the student, the educational system is configured to assess the student's understanding and mastery of the subject matter and skills associated with each learning objective. Thus, the educational system advantageously provides objective evaluation of the effectiveness of the classroom teacher. The evaluation of the teacher's effectiveness enables an academic institution to assist teachers who may be struggling with effectively delivering a particular subject matter. The educational system also enables a teacher to understand which particular skills or concepts a student may be struggling to understand or master. The educational system also enables a parent to determine or evaluate whether the student is spending enough time performing homework. These and other advantages will be discussed in more detail in the following embodiments that are described and illustrated below in FIGS. 1-9.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Various embodiments of the invention are described below. The following description provides specific details for a thorough understanding and an enabling description of these embodiments. One skilled in the art will understand, however, that the invention may be practiced without many of these details. In addition, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

Turning now to FIG. 1 of the drawings, there is shown an environment 100 within which embodiments of the invention may be practiced. As will be seen, the environment 100 comprises a client system 102 coupled to a server system 104 via a communications network 106. An education system having the functionality described herein operates on server system 104. The client system 102 may represent any client-computing device including e.g. a personal computer (PC), a notebook computer, a smart phone, etc. At least conceptually, the client system 102 may be thought of as including one or more input/output (I/O) devices 108 coupled to a host system 110. In accordance with different embodiments, the I/O devices 108 may include input devices such as a computer mouse or pen, a touch-sensitive screen, joystick, data gloves, and a keyboard. Additionally, the input devices 108 may further comprise input devices for capturing biometric information pertaining to a learner. The latter category of input devices may include a camera for facial expression detection and for eye motion capture/detection, a voice recorder, and a heart rate monitor. The I/O devices 108 may include output devices such as a display, a sound playback device, or a haptic device for outputting braille. Although in FIG. 1 only one client system 102 is shown, it is to be understood that in practice several such client systems 102 may be coupled to the server system 104 via the communications network 106.

In a broad sense, the communications network 106 represents any network capable of bridging communications between the client system 102 and the server system 104. For purposes of the present description, the communications network 106 is to be understood to include a Wide-Area Network (WAN) in the form of the World Wide Web (WWW) or the Internet, as it is commonly referred to. The server system 104, in one embodiment, may comprise a Web server housed in a data center. In one embodiment, the server system 104 may be implemented as a server farm or server cluster. Such a server farm may be housed in a single data center or in multiple data centers.

At a high-level, the server system 104 provides educational/learning content in the form of lessons that are executed on the client system 102. The lessons serve to teach one or more skills and assess a student's comprehension or mastery of each skill. Responsive to the execution of the lessons, the client system 102 captures a student's responses and transmits them as inputs to the server system 104 for assessment and lesson sequencing, as will be described later.

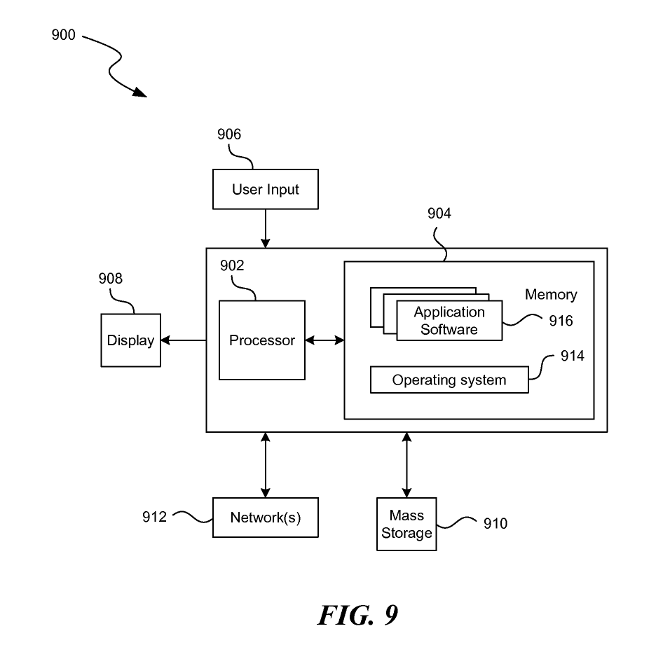

The server system 104 includes a student profile database 112, a standards database 114, and a lesson database 116. Additionally, the server system 104 includes a student assessment engine 118, a lesson adapter 120, a sequencer 122, and a lesson delivery engine 124. Hardware that may be used to realize or implement the server system 104, in accordance with one embodiment of the invention, is illustrated in FIG. 9. As noted above, in one embodiment, the server system 104 may be implemented as some or all of a server farm or in another distributed computing environment. The server farm may be housed in a single data center or in multiple data centers and may serve a large number of students.

In one embodiment, the student profile database 112 comprises individual student profiles. Each student profile may comprise personal information such as a student's age, gender, geographic location, interests and hobbies, etc. Each student profile may include summaries of the students' academic performance, academic strengths and weaknesses, and/or individual goals that may have been set by the student, by a parent, or by an educator for the student.

The standards database 114 includes standards that a student should achieve. A standards authority typically defines the standards stored in the standards database 114 for use by the server system 104. Examples of standards authorities include federal educational departments, state educational departments, district or other local educational departments, or other policy-setting body. Each standard is typically broken down into one or more skills that a student must master in order to meet the requirements of the standard. The standards database 114 may be specific to a single subject or may encompass multiple subject matters. In some embodiments, the standards database 114 includes standards relating to mathematics, science, reading, and history.

The lesson database 116 includes lessons that may be presented to a student in order to teach the student a desired skill or skills and to assess the student's progress in learning those skills. For example, lessons that teach and assess skills that are associated with a “numbers' in fractions” standard may include adding fractions, subtracting fractions, multiplying fractions, dividing fractions, and mixed number conversion of fractions. The server system 104 adaptively provides lessons to each student based on the student's ability to comprehend and master the skills associated with those lessons. In particular, the server system 104 may be configured to quickly move from one lesson to another lesson when the student shows quick mastery of skills. The server system 104 may be configured to then cause the student to spend more time, i.e., slow down, on lessons or skills that take the student longer to understand or master. Accordingly, for each lesson, the lesson database 116 includes facts, problems, questions, learning tools, visual representations, illustrative examples, animations, movies, and/or audio clips, which may be selectively presented to the student based on the individual needs of data student. According to various embodiments, each lesson is associated with one or more specific skills that are associated with a standard.

For purposes of this description, a learning objective is a standard, skill, or lesson that a system operator desires a student to achieve or master. For example, a learning objective may be defined as a scientific skill that a student should master. To demonstrate mastery, the system may present two lessons to the student that are designed to teach elements of the scientific skill. If the student successfully completes the two lessons, the learning objective is met. As another example, a learning objective may be a standard that a student must achieve in mathematics. The standard is associated with skills and with lessons that are presented to the student by the system. If the user successfully completes the presented lessons, the learning objective is met. As yet another example, the learning objective may be single lesson. If the student successfully completes the lesson, the learning objective is met.

Operations and capabilities of the educational system 104 may include features that are similar to the educational system described in co-pending U.S. patent application Ser. No. 11/777,984, which is hereby incorporated herein by reference.

The server system 104 uses the student assessment engine 118 and the lesson adapter 120 to assess the student's academic strengths and weaknesses and to provide content that is customized and tailored to the particular student's needs. In some embodiments, the student assessment engine 118 monitors the student's interactions with lesson content and uses the interactions to calculate a rate by which the student is able to learn new skills, i.e., a learning velocity (LV). The interactions monitored by the student assessment engine 118 may include, among other things, answers to questions, the time it takes for a student to respond, the number of responses made by the student before a correct answer is selected, changes made to answers, mouse overs, and other indications of hesitation or uncertainty. The student assessment engine 118 may use one or more interactions to determine the learning velocity of the student in terms of seconds, minutes, hours, days, months, school years, or any other time frame. For example, a learning velocity of 0.1 skills per minute (spm) indicates that a student is capable of acquiring one tenth of a new skill per minute (i.e., 1 skill per 10 minutes). More generally, the learning velocity may have the units of weight per minute (wpm) and may indicate how much of a learning objective a student is capable of completing within a minute, as measured against a weight representing the complexity of the learning objective. The learning velocity is a dynamic number that the student assessment engine 118 calculates while monitoring the student's interactions with the server system 104. In some embodiments, the student assessment engine 118 continuously assesses the learning velocity of the student. In other embodiments, the student assessment engine 118 periodically assesses the learning velocity of the student. For example, the student assessment engine 118 may be configured to calculate the learning velocity once every half-hour, once per lesson, after each assessment of a particular skill, or after the completion of a standard (e.g., a group of related skills and/or lessons). As will be discussed below, a students learning velocity may be used to determine how quickly the student will progress through multiple learning objectives, such as lessons, standards, or skills.

Initially, the server system 104 may not have any information from which to estimate or calculate a student's learning velocity. In such a situation, the server system 104 or the student assessment engine 118 may calculate or estimate a learning velocity from historical data for the student (such as from a student's past grades), or use an historical average of students that are part of the same class, from the same school, or are otherwise considered a peer group as the student.

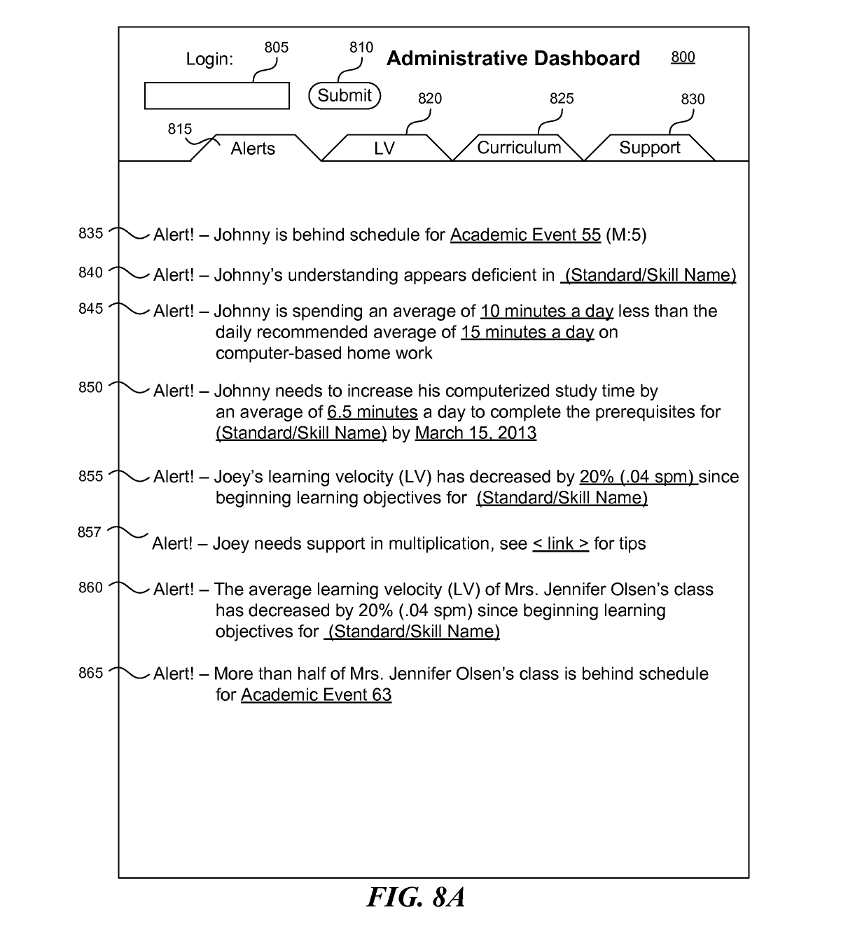

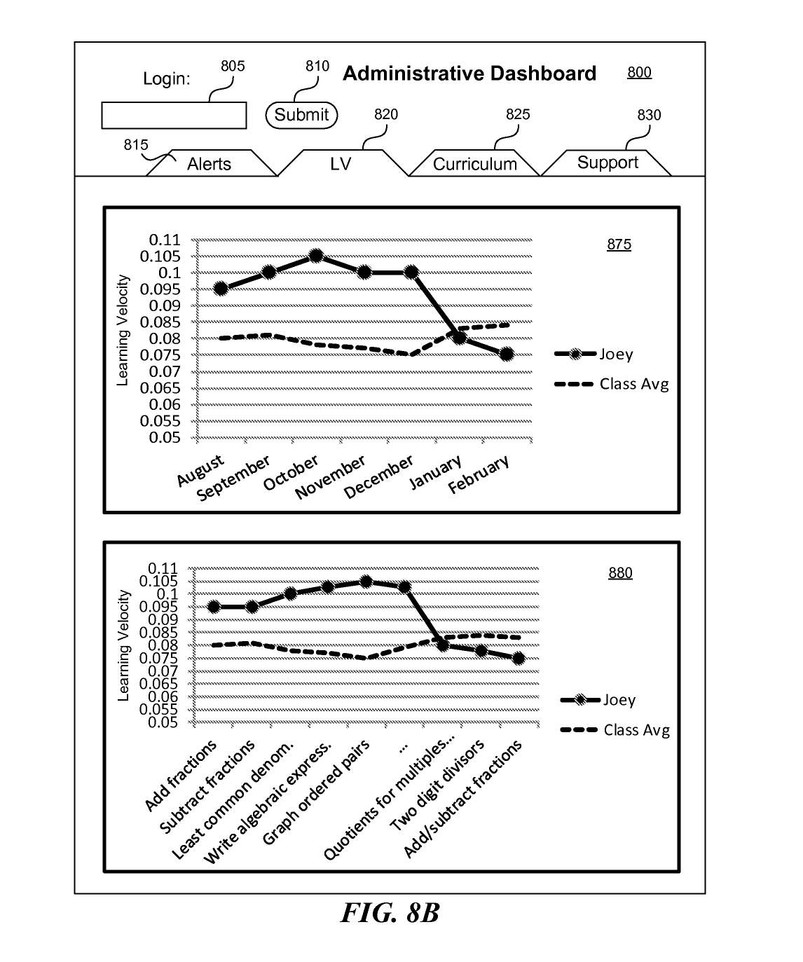

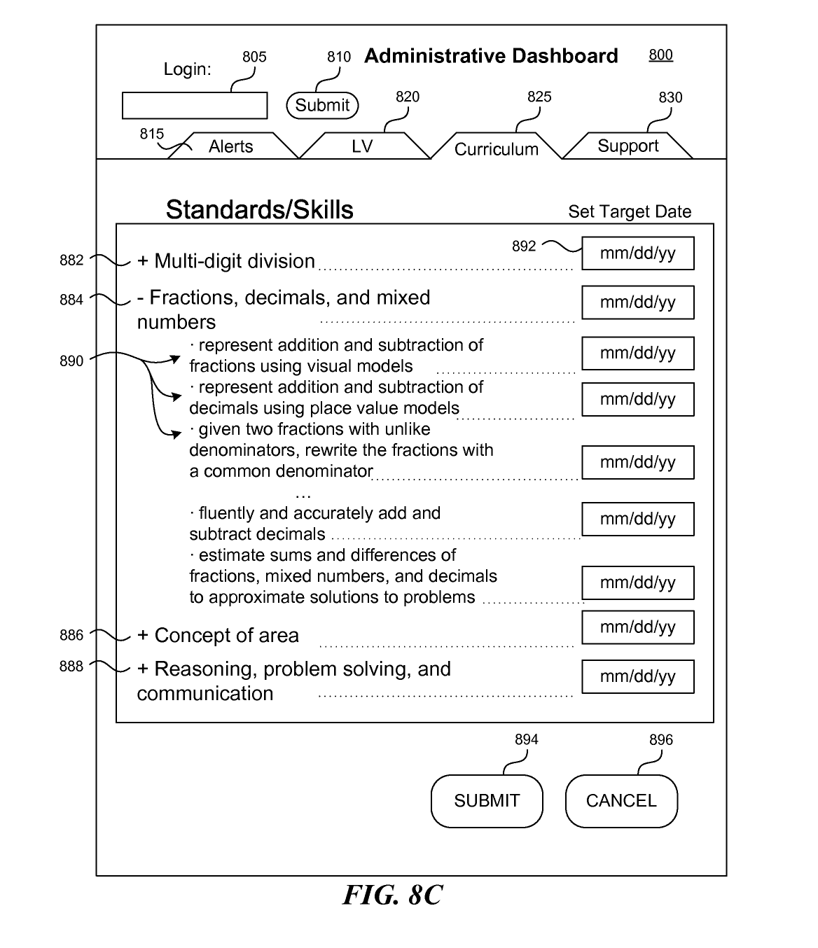

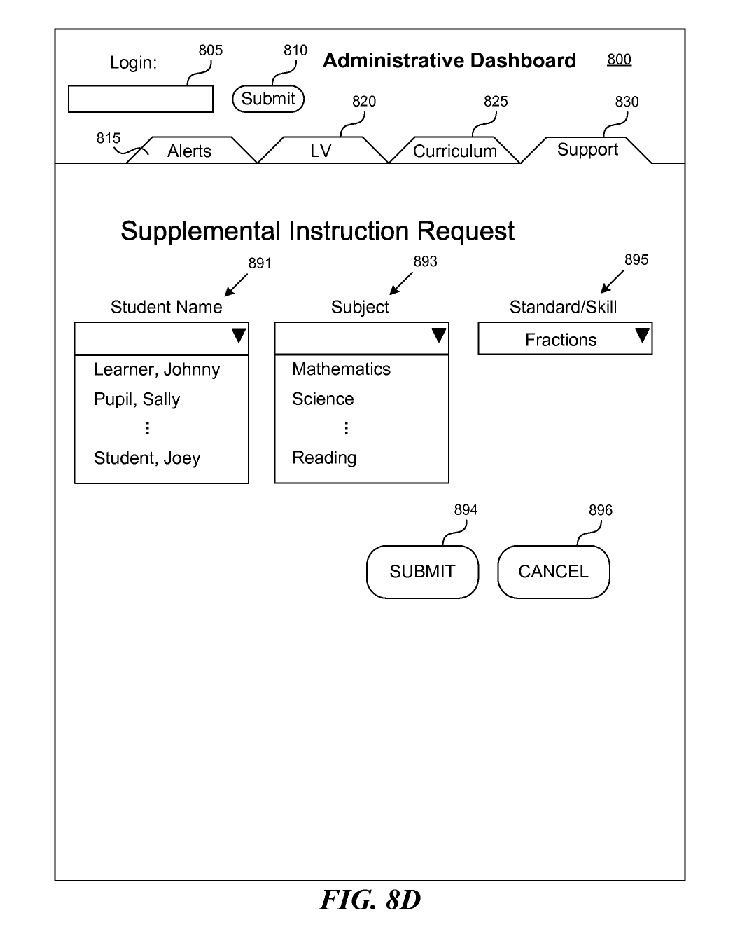

The server system 104 may use information generated via the student assessment engine 118 to vary the content provided by the lesson adapter 120. In particular, the lesson adapter 120 may vary the difficulty of problems used to assess a particular skill, may vary the duration spent on covering fundamentals of a new skill prior to teaching the application of the skill, may vary the time allotted for the student to provide responses, or the like. The server system 104 may use the lesson adapter 120 to confirm the calculated lesson velocity of the student. For example, if a students learning velocity decreases during a lesson covering the multiplication of fractions, the server system can increase the number of questions or problems presented to the student to ensure or confirm that the student understands a particular principle associated with the skill. As will be discussed in connection with FIGS. 8A-8B, in response to discovering an area of difficulty for a student, the server system 1d4 may generate an alert and notify one or more people about the skill or subject matter the student may not be understanding.

The lesson adapter 120 may also be configured to compensate for differences in attention spans of children based on age, grade, and learning ability, and may vary the duration of lessons accordingly. For example, the lesson adapter may limit the duration of lessons for third graders to 30 minutes while extending lessons for fifth graders to 45 minutes. The server system 104 for may use timers in conjunction with the student assessment engine 118 and the lesson adapter 120 to estimate the attention span of each child. In other words, if the server system 104 detects a reoccurring pattern that a student's learning velocity begins to decrease by 20% when a lesson extends beyond 40 minutes, the server system 104 may adapt the presented lessons to terminate at or before the detected 40 minute threshold of the student.

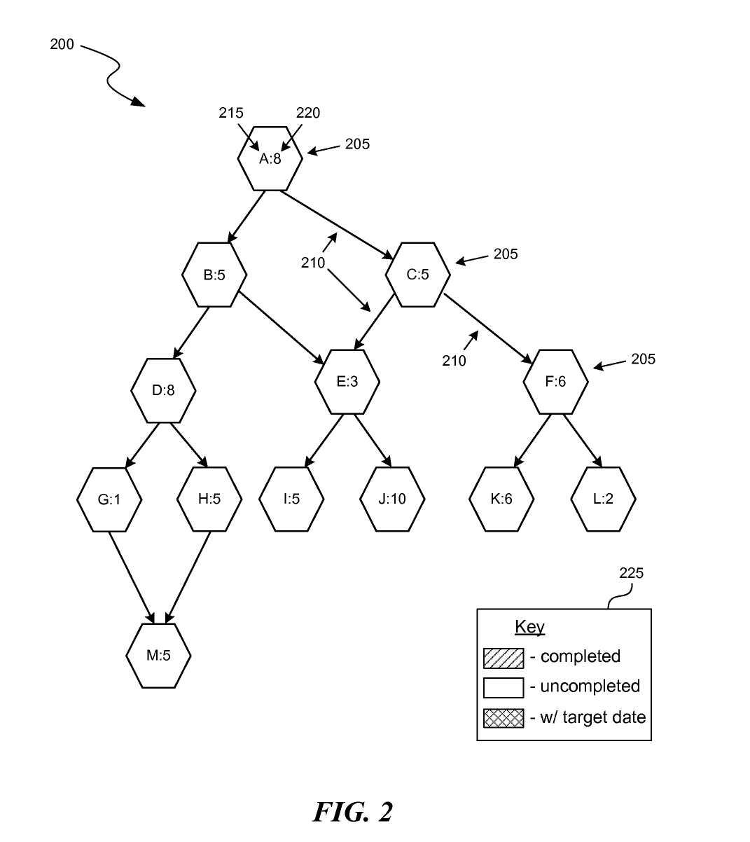

The server system 104 includes a sequencer 122 to implement the sequencing method described below with reference to FIGS. 2-7. As will be discussed, the sequencing method described in FIGS. 2-7 may be used to synchronize the learning objectives provided to a student with the goals or predetermined curriculum of a school or other academic institution.

In one embodiment, the sequencer 122 implements Calendar-Driven Sequencing (CDS) to make decisions based on a schedule established by the school, or other customer. By synchronizing the academic guidance provided by the sequencer 122 with the school's existing and planned academic schedule of lessons and tests, the sequencer 122 enables the server system 104 to help educators and institutions to achieve their goals of enabling students to receive a customized amount of instruction that is tailored to the bandwidth and/or capacity of the student. As will be discussed below, the sequencer 122 enables students to receive instruction according to the individual students bandwidth by individualizing the sequence of learning objectives presented to each student. The sequencer 122 enables the server system 104 to add skills, lessons, and/or standards to a student's sequence of learning objectives when the student has the capacity to receive more information within an allotted period of time. Additionally, the sequencer 122 enables the server system 104 to remove skills, lessons, and or standards from a student's sequence of learning objectives when the minimum required learning objectives fill the student's capacity for acquiring new information.

FIG. 2 illustrates a graph 200 of multiple learning objectives 205 grouped and linked in a hierarchy of predecessor learning objectives and successor learning objectives, i.e., a tree structure. The graph 200 includes a plurality of uncompleted learning objectives 205 hierarchically connected via links 210. The graph 200 illustrates relationships between uncompleted learning objectives that may be used by the sequencer 122 to deliver a customized sequence of learning objectives to a student. A sequencing graph (or hierarchical “tree”) represents a convenient way to visualize the learning objective hierarchy that the server system 104 uses to perform learning objective sequencing. Each of the links 210 start at a predecessor learning objective and terminate at a successor learning objective. Thus, for any learning objective (e.g., C:5), links 210 may be traced to determine all predecessor learning objectives associated with each successor learning objective.

In some embodiments, each learning objective 205 includes several characteristics. A first characteristic is the content 215 of the learning objective, illustrated in FIG. 2 by the use of a capital letter, e.g., ‘A’. The content 215 of each learning objective may be different from each other, or may be the same but placed on independent branches of the hierarchical tree. Each learning objective has a second characteristic that is a weight 220 of the learning objective, illustrated in FIG. 2 by the use of a number, e.g., ‘8’. Each weight 220 represents a level of complexity associated with the learning objective to which it is assigned. The weights 220 may be on a scale of 1 to 10, 1 to 50, 1 to 1000, and so forth, depending upon the amount of granularity designed into the server system 104. Each weight may be determined based on the observed difficulty of the learning objective for a group of students. The server system 104 may vary the weight with time based on further observations. According to various embodiments, the level of complexity may vary according to the difficulty of the content 215, according to the quantity of the content 215, or according to the duration it typically takes students to complete the learning objective 205. As an example, a learning objective 205 that takes an average student 8 hours to complete may have an assigned weight 220 of ‘8’, whereas a learning objective 205 that takes an average student two hours to complete may have an assigned weight 220 of ‘2’.

Each learning objective has a third characteristic that indicates whether a student has completed the learning objective 205. In FIG. 2, whether a student has completed the learning objective is illustrated by shading of the corresponding node, i.e., striped if a student has completed the learning objective and clear if a student has not completed the learning objective. While graph 200 and subsequent graphs apply a binary indication for whether a learning objective 205 is completed, further granularity may alternatively be illustrated. For example, either within the server system 104 or merely on the graph 200, each learning objective 205 may have associated with it an indicator describing how much of the learning objective 205 the student has completed, e.g., 10%, 33%, 75%. The graph 200 includes a key 225 to provide quick reference to the status of the learning objectives. The graph 200 may merely be an organizational construct maintained by the system, or it may be a graphical user interface generated by the system and presented to a system user.

As shown in the key 225, each learning objective 205 may also have a fourth characteristic that represents whether a target date or range of target dates has been assigned to that particular learning objective 205. A learning objective 205 becomes a “target learning objective” or an “academic event” (AE) when the server system 104 assigns or associates a target date or dates with the learning objective. Within the graph 200 or subsequent similar graphs, a target learning objective or academic event will be distinguished from other learning objectives with a crisscross pattern.

According to various embodiments, the server system 104 creates a target learning objective by assigning one or more target dates to one of the learning objectives 205 in response to an input from an academic institution, a teacher, a parent, or other administrator. As will be illustrated in FIG. 8C, the server system 104 may receive the target dates or target dates from a user via a webpage or other user interface. In one embodiment, target learning objectives may become “magnetic attractors” associated with calendar ranges. The term “magnetic attractors” is used to convey the idea that the sequencing of the learning objectives will be drawn towards or directed towards the target learning objective. In some embodiments, a target learning objective or academic event may be characterized as a duple, i.e., a construct comprising (1) an area of subject matter or of a curriculum, and (2) a calendar date or range of dates. The relationship between the target learning objective within the hierarchy of learning objectives illustrated by the graph 200 may be called the location of the target learning objective. The calendar date or range of dates may be called the target date.

As discussed above, each learning objective 205 may represent an academic standard, one or more lessons, a particular skill, or the like. Thus, the graph 200 represents a linked hierarchy of academic standards, a linked hierarchy of lessons, or a linked hierarchy of skills. In some embodiments, each of the learning objectives 205 represents an academic standard, each of the academic standards includes a linked hierarchy of lessons that is similar to graph 200, and each of the linked hierarchy of lessons includes a linked hierarchy of skills that is similar to graph 200. Accordingly, the linked hierarchy of learning objectives 205 represented by graph 200 may merely be representative of one of a number of layers of linked hierarchies of learning objectives. In some embodiments, some skills used in one lesson or standard may also be used in one or more other lessons or standards.

To summarize, the graph 200 represents a hierarchy of learning objectives 205. Each of the learning objectives 205 includes a content 215 and a weight 220. Each of the learning objectives 205 is linked to other learning objectives 205 according to predecessor-successor relationships, i.e., parent-child relationships. All predecessor learning objectives may include prerequisite subject matter for each learning objective that is downstream or dependent from the predecessor learning objectives. Each learning objective 205 may also have a completed status, uncompleted status, and/or may have a target date associated with the learning objective. Each learning objective may also have other characteristics such as anticipated length to complete, numbers of lessons or skills or concepts covered, or the like. The server system 104 uses the hierarchical relationship of the learning objectives to provide an individualized sequence of learning objectives to keep a student's learning sequence synchronized with the goals of an academic institution, while concurrently filling the learning capacity of the student.

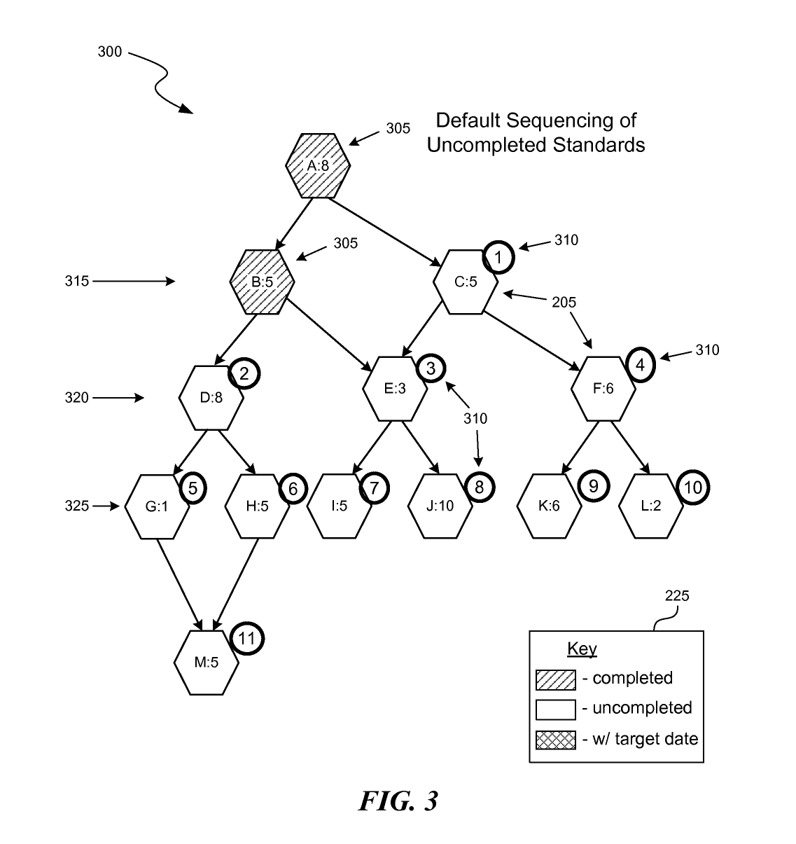

FIG. 3 illustrates a graph 300 that shows a default sequencing of learning objectives. In addition to the uncompleted learning objectives 205, the graph 300 includes completed learning objectives 305 and sequence numbers 310. The sequence numbers 310 range from 1 through 11 and show a default sequence that the server system 104 may use to progress the student through the learning objectives 205 in an organized manner. As shown, the sequence numbers 310 begin from C:5 and continue through M:5. Accordingly, in one embodiment, the server system 104 may provide the uncompleted learning objectives 205 to a student in an order of a first tier of learning objectives 315, followed by a second tier of learning objectives 320, followed by a third tier of learning objectives 325, and so forth.

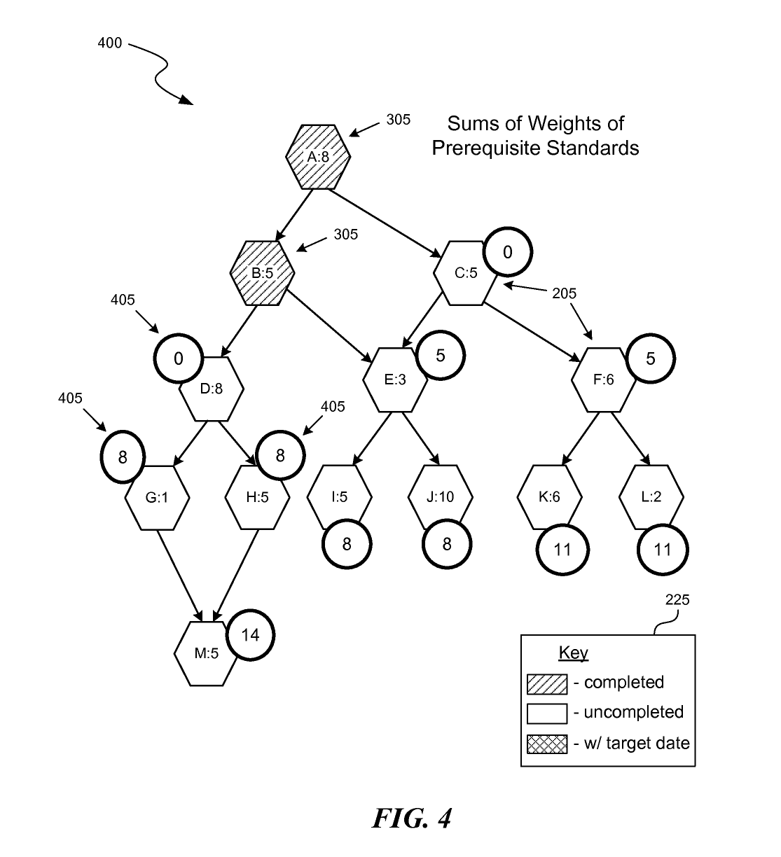

FIG. 4 is a graph 400 that illustrates a relationship between the weights associated with predecessor learning objectives and successor learning objectives. The server system 104 tracks a prerequisite weight 405 for each uncompleted successor learning objective 205. The prerequisite weight 405 of a particular learning objective represents the sum of all uncompleted learning objectives 205 that precede that particular learning objective. For example the learning objective represented by the content and the weight of D:8 has a prerequisite weight of 0 because all learning objectives that precede D:8 have been completed, i.e., learning objectives A:8 and B:5. As another example, the learning objective identified as M:5 includes a prerequisite weight 405 of 14 because learning objectives identified as D:8, G:1, and H:5 have a weights 220 of 8, 1, 5, respectively. The sum of 8, 1, and 5 is 14, thus the learning objective 205 identified as M:5 has a prerequisite weight 405 of 14. In some embodiments, the prerequisite weight 405 is called an “academic distance” (AD) of a student to the learning object having the prerequisite weight 405. In other words, the prerequisite weight 405 or academic distance represents the complexity or magnitude of the prerequisites the student needs to achieve, complete, or master in order reach the beginning of the target learning objective. The academic distance is a function of the location of the student in the sequence of learning objectives and a function of the location of the target learning objective.

The server system 104 advantageously uses the identification and calculation of prerequisite weights 405 to estimate how much time a particular student needs to progress from a completed learning objective 305 (e.g., B:5) to an uncompleted learning objective 205 (e.g., M:5). For example, as discussed above, the learning velocity (LV) of a student represents how many skills or how much learning objective weight a student can achieve or complete per minute. The academic distance represents the sum of prerequisite weights between learning objectives 305 and learning objectives 205. Following equation (1), the estimated time distance (ETD) of a student from a completed learning objective 305 to an uncompleted learning objective 205 may be calculated as:

ETD=AD/LV (1)

Using example numbers in equation (1), if a student has a learning velocity of 0.1 weight per minute and wants or needs to progress from completed learning objective 305 indicated by B:5 to uncompleted learning objective 205 indicated by M:5, the student's estimated time of time of traversal between B:5 and M:5 is 140 minutes (i.e., 14/0.1). Accordingly, if the student studies the uncompleted learning objectives 205 for an average of 14 minutes a day, the student can complete the prerequisites for M:5 in approximately 10 days.

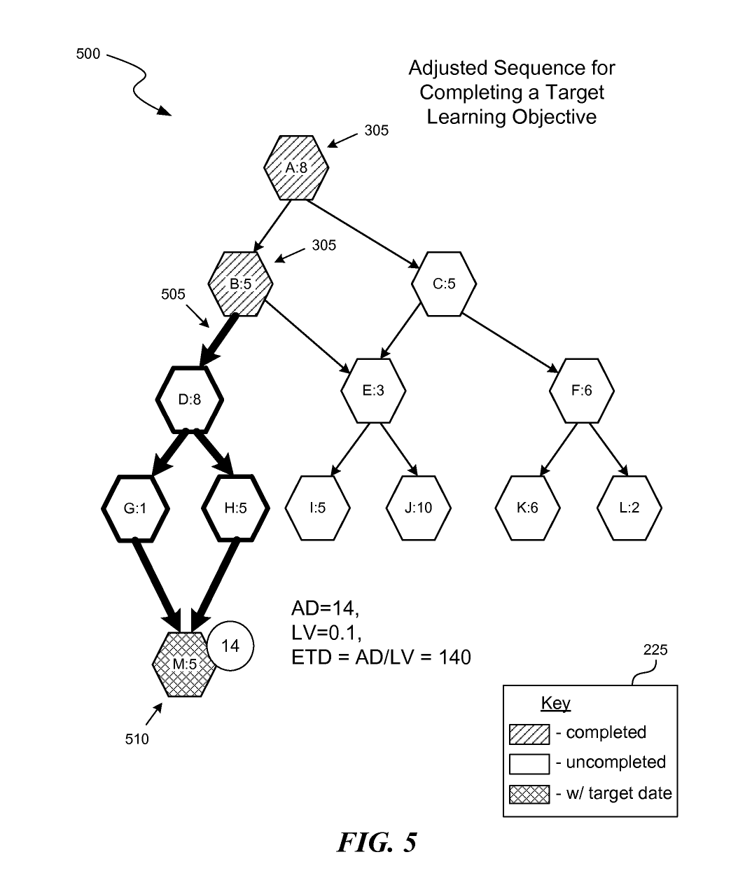

FIG. 5 illustrates a graph 500 that represents calculations made by the server system 104 to determine a path from a completed learning objective to a target learning objective. The path may be a critical path or an optimal path. The graph 500 includes path 505 and target learning objective 510. As described in connection with FIG. 4, the sum of the weights of predecessor learning objectives for the target learning objective 510 is 14 in the depicted graph.

The server system 104 may dynamically alter the sequence of learning objectives provided to the student based on one or more target learning objectives 510 identified by an academic institution, teacher, parent, or the like. For example, while traversing through uncompleted learning objectives 205 using a default sequence illustrated and described by FIG. 3, the server system 104 may abruptly alter the sequence of lessons delivered to the student so that the student reaches, achieves, or completes the target learning objective 505 by a target date or within a range of target dates determined by an academic institution, teacher or parent. In some embodiments, the target dates or range of target dates may coincide with important academic events, such as state or national standardized tests. In other embodiments, the target dates assigned to learning objectives correspond with vacations or breaks from school, for example, Spring Break.

For any given student, a scheduled target learning objective remains active until it expires (i.e., the target date or range of dates passes, or until the student achieves it) or until it is changed. There may be more than one target learning objective active at once, according to some embodiments. For the purposes of the examples provided herein, it is assumed that there is only one target learning objective that is active at a time. The sequencer 122, may detect or track active target learning objectives and guide the student to the target learning objective with the goal of reaching it by the beginning of the target date.

To illustrate the sequencing method described above, consider the following example:
A school plans to be working on multiplications of fractions by whole numbers (target learning objective) between February 1st and February 15th (target date range). That part of the hierarchy of learning objectives becomes a magnetic attractor that influences the sequencer toward it with increasing strength leading to the first two weeks for February. The work assigned to the students by the sequencer in January, leading to the target learning objective, will be around preparation for the February material and its pre-requisites. The lessons presented by the sequencer during the first two weeks in February will be, if possible and if the student is ready, lessons related to multiplication of fractions by whole numbers. Otherwise the lessons will be lessons chosen to teach prerequisites for that material.

In one embodiment, there are 3 fundamental variables that influence how the calendar driven sequencing behaves, namely, academic distance (AD), time distance (TD), and learning velocity (LV). The “pull” of a target learning objective, or its “magnetic attraction,” at any given time is directly proportional to the academic distance, inversely proportional to the time distance, and inversely proportional to the learning velocity. The academic distance and learning velocity have been discussed in detail above.

The server system 104 calculates, generates, or determines the time distance for a student to estimate how many minutes the student is scheduled to dedicate to learning objectives between a present time and the one or more scheduled target dates. The server system 104 uses the time distance to determine whether or not the student is spending enough time, on average, to achieve the target learning objective by the target date. The time distance between a student and a target learning objective at any given time is a function of the calendar distance between the present time and the start time of the target learning objective, and is a function of the average number of minutes the student studies per day. The server system 104 may determine the average number of minutes the student dedicates to (or plays with) the learning objectives by summing the amount of time the student spends for several days, e.g., 2 weeks, and then dividing the summed amount of time by the number of days summed. If the student has not used the system enough to allow for a reasonable estimation, the student's time distance may be inferred and predicted based on historical data or based on statistical averages for other students close to the student (for example, students of the same class or school).

The server system 104 notifies an administrator, a teacher, a parent or other party when a student's estimated time distance is less than a student's calculated remaining time distance. In other words, if the amount of time the student spends on the learning objectives is insufficient for the student to arrive at, achieve, or complete a target learning objective, a responsible person is notified so that one or more remedial measures may be started to assist the student to achieve the goal. The server system 104 may provide one or more of any number of recommendations for, remedial action to the administrator, teacher, or parent. According to various embodiments, remedial actions may include notifying the teacher of the specific subject area in which a student is struggling. For example, a student may be taking an unusually long amount of time on the skill or learning objective for multiplying fractions. By notifying the teacher that the student is struggling with this subject area or skill, the teacher may provide additional attention to the student. Another example of a remedial action the server system 104 may recommend is that the student dedicate more time towards the learning objectives. For example, if the student has a remaining time distance of 120 minutes and has a calculated remaining time distance of 140 minutes (i.e., a 20 minute deficiency), the server system 104 may recommend that the student dedicate an additional 2 minutes per day for 10 days to make up for the 20 minute deficiency. In another example, the server system 104 may generate a report that provides a list of skills that the student is having difficulty with. As will be discussed with respect to FIG. 8, the server system 104 may graphically illustrate which skills a student is having difficulty by providing graphs of a students learning velocity as it relates to specific skills, lessons, standards, or other learning objectives. In some embodiments, the server system 104 may graphically represent the student's learning velocity on the same graph as an average learning velocity of the student's classmates, age group, or other peer group.

Although the critical or optimal path 505 has been described as the shortest path, in other embodiments, the optimal path may be the path with the easiest subject matter, subjectively or objectively. In other words, it may be possible for the server system 104 to get a student from completed learning objectives 305 to the target learning objective 510 via a path other than a critical or optimal path 505.

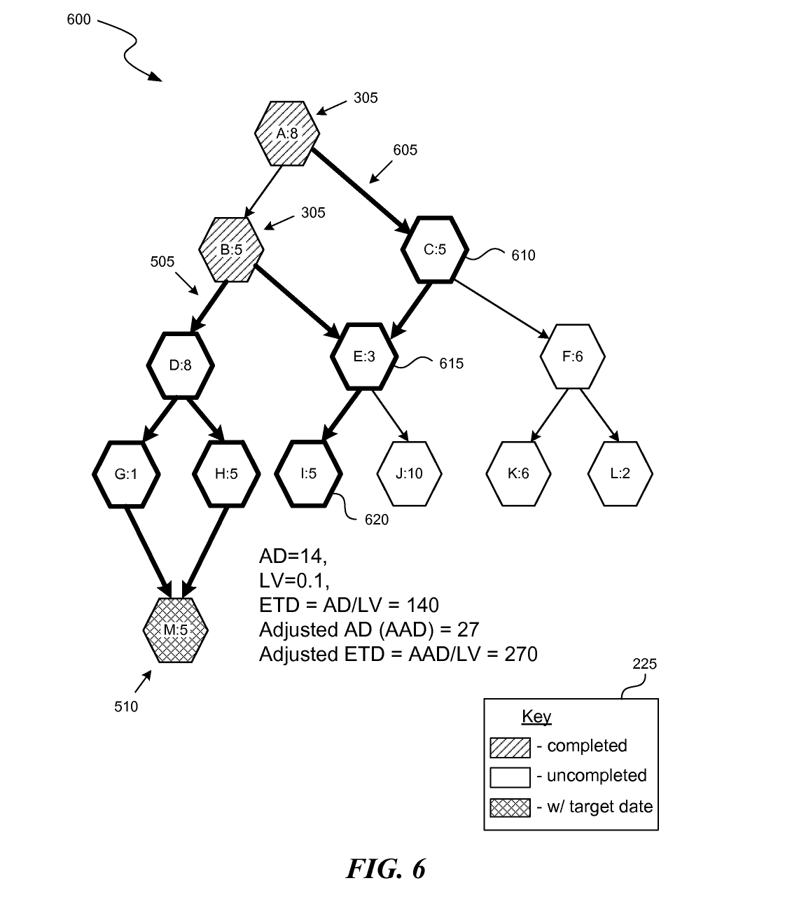

FIG. 6 illustrates a graph 600 representing an action taken by the server system 104 if a student is scheduled to complete all prerequisite learning objectives much faster than the student's estimated time distance. The graph 600 still illustrates the critical or optimal path 505 between the completed learning objective 305 and the target learning objective 510. However, the server system 104 may also generate a noncritical path 605 for a student having the bandwidth or capacity. For example, if the academic distance between a completed learning objective 305 and the target learning objective 510 is 14 (i.e., AD=14), and if the student's learning velocity is 1 skill per 10 minutes (LV=0.1), then the estimated time distance from the completed learning objective 305 (B:5) to the target learning objective 510 is 140 minutes. Continuing the example, if the server system 104 estimates that between the present time and the target date of the target learning objective 510, the student is estimated to dedicate approximately 300 minutes to studying the uncompleted learning objectives 205, the server system 104 will determine that the student has 160 minutes available to acquire additional skills in addition to those skills that are prerequisite to achieving the target learning objective. In response, the server system 104 may adjust the sequence of learning objectives provided to the student to enable the student to cover additional learning objectives that are not part of the critical path 505. In other words, the server system 104 dynamically adjusts the sequence of learning objectives provided to the student, based on the student's availability and ability to acquire new skills and participate in additional lessons. As illustrated by the graph 600, the server system 104 may add noncritical path 605 to the student's sequence of learning objectives. The noncritical path 605 may include the uncompleted learning objectives 610, 615, and 620. The sum of the weights of the learning objectives of critical path 505 and the weights of the learning objectives of the noncritical path 605 is 27. Accordingly, the adjusted academic distance (AAD) that includes critical path 505 and non-critical path 605 is 27 (i.e., AAD=27). Using the previously discussed equation for calculating estimated time distance, an adjusted estimated time distance that accounts for the noncritical path 605 is:

Adjusted ETD=AAD/LV=27/(0.1)=270

Advantageously, the server system 104 is able to provide individually tailored lessons to students to fill the students capability, bandwidth, or capacity to acquire new skills and/or additional information while concurrently ensuring that, when possible, a student fulfills, achieves, or completes learning objectives that are prerequisite to beginning, achieving, or completing a target learning objective.

According to various embodiments, the server system 104 may employ various strategies for the re-evaluation of academic distance, learning velocity, and time distance for a student. As discussed above, some of these techniques include continuously re-evaluating the parameters, or periodically re-evaluating the parameters. For continuous re-evaluation, the academic distance, learning velocity, and time distance are re-evaluated continuously during the student experience. This will ensure that the sequencer 122 or server system 104 adjusts its pull toward the target learning objective as time passes. For scheduled re-evaluation, the academic distance, learning velocity, and time distance are re-evaluated off-line based on a schedule. This can be used for performance reasons or to ensure that the student experience does not change too much during the life of a session.

In some cases, it is entirely possible that a student that seems to have plenty of time to reach the target learning objective might find difficulties along the way, and might need to be sent backwards in the sequence of learning objectives to practice skills that seem to be missing, did not sufficiently master, or that the student has forgotten. Also, a student could be dedicating less time to the learning objectives, thereby increasing the estimated time distance.

The estimated time distance might also be subject to any number of adjustments based on other variables such as historical records of the student, historical records of related students, students' categories, etc. For example, if a class of a student is known to be slower than the average, the estimated time distance might be adjusted to reflect that.

In any case, when the estimated time distance increases and the pull toward the target learning objective increases, the sequencer 122 or the server system 104 may decrease, reduce, or eliminate the alternative parallel paths that the sequencer recommended previously.

In case the estimated time distance decreases, the pull toward the target learning objective will decrease, allowing the server system 104 to add more paths and practice into the students sequence of learning objectives.

In one embodiment, the sequencer 122 may adjust more than just the path it takes in order to reach an academic event in time. The sequencer 122 or server system 104 can also adjust other strategies such as:
Amount of practice lessons given within a learning objective.
The ability to rapidly advance through learning pathways, of previously or externally mastered material, may be turned off to increase the time spent in a particular path.
Number of problems and/or questions given per learning objective in the path.
Skip forward past some lessons (e.g., easiest or hardest lessons) if the student is doing well and the target learning objective is approaching.
The engagement layer built around the academic content could be adjusted to allow for more or less time spent in extra non-academic material. For example, parts of the engagement layer such as games or activities could be locked to adjust the student focus on task.

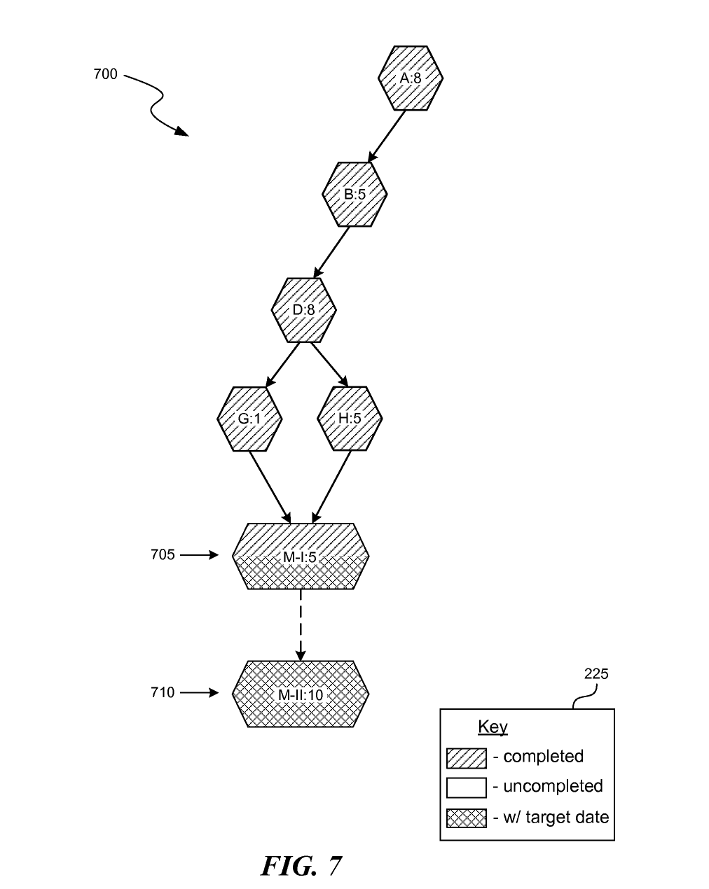

FIG. 7 illustrates a graph 700 showing how the server system 104 may proceed in a sequence of learning objectives when a student begins work towards a target learning objective. The graph 700 shows a partially-complete target learning objective 705 and a new target learning objective 710. Accordingly, in some embodiments, if there is a subsequent target learning objective in the academic calendar, the sequencer 122 or server system 104 recalculates the academic distance, learning velocity, and time distance for the new event and repeats the methods of operation described above.

In one embodiment, if a student reaches and completes the academic content of target learning objective before the target date, the pull of target learning objective can either continue to related standards at a higher level, if they exist, or its pull can disappear if there are no related standards at a higher level. Consequently, the server system 104 may return to a default mode of sequencing the learning objectives.

In one embodiment, the same consideration applies in the case that a student has already mastered the material covered by a target learning objective before reaching a target date. The pull in that case continues to the next learning objective, or is terminated in case higher levels don't exist in the sequence of learning objectives.

The choice of what strategy to take (moving on to higher levels or ignoring the magnetic pull) may also be determined on a case-by-case basis as part of the parameters of the AE, in accordance with one embodiment.

In some embodiments, the weight of the learning objectives can be adjusted automatically depending on the historical learning velocity of the students in each learning objective, with the intent of keeping the average learning velocity constant per student on all learning objective. That is, the server system 104 may take into consideration the average learning velocity of a group of students and adjust for errors in the initial evaluation of the weight of the learning objective.

Alongside a calendar of target learning objectives, the server system 104 may also provide a calendar of events (e.g., holidays, half days, field trips, etc.) that can affect the amount of time that a student can utilize the system per day and, consequentially, the time distance of a student to the target learning objective. Additionally, there might be multiple target learning objectives active at the same time for a given student scheduled for the same or overlapping times. In that case, some embodiments could combine these into one target learning objective with a single estimated time distance and academic distance calculated.

FIGS. 8A-8D illustrate a representative administrative dashboard 800 that is generated by the system for use as a graphical user interface by an administrator, a teacher, a parent, or the like. The administrative dashboard 800 includes a login box 805, a submit button 810, and alerts tab 815, a learning velocity tab 820, a curriculum tab 825, and a support tab 830. The login box 805 accepts credentials from a user to log into the administrative dashboard 800. The server system 104 may receive a user's login credentials and provide information and/or tabs to the user according to the privileges or preferences that are associated with the user. Each of the tabs 815-830 provide different information, and each will be described below.

FIG. 8A illustrates the alerts tab 815 that the server system 104 uses to display alerts to notify an administrator, teacher, parent or other individual of potential concerns detected by the server system 104. The alerts displayed on the alerts tab 815 may be informational or may include recommendations for remedial action for assisting one or more students with achieving a target learning objective. One or more of the alerts shown may be displayed concurrently, or individually. Alert 835 may be used to notify a teacher that a student is behind schedule to achieve an academic event, for example, an academic event 55. Alert 840 may be used to notify a teacher of a particular area that a student is struggling with. For example, the alert 840 may indicate that a student is struggling with a specific standard or skill. Alert 845 may alert a teacher or a parent that a student is behind schedule for an academic event and may display how much or how little time the student the spending on computer-based homework. Alert 850 may recommend remedial action in the form of a recommendation to increase study time, to assist the student in achieving a particular academic event or target learning objective. For example, the server system 104 may recommend a particular number of additional minutes of study time a day to help the student catch up, e.g., 6.5 minutes. Alert 855 may alert a teacher or parent of a change in a student's learning velocity (e.g., a decrease of 20%) since the beginning of a particular learning objective. The alert 855 may specifically list which standard, skill, or other learning objective the student was working on when his or her performance began to decrease. Alert 857 may alert a teacher or parent of a subject, standard, skill, or other academic area in which the student needs additional support. The alert may also provide a link that prescribes remediation. The link may be an HTTP link that opens a webpage, the link may open another page within the administrative dashboard 800, or the link may cause a pop-up window to appear and display one or more recommended actions to help the student.

In addition to alerts that are directed towards a teacher or a parent, the server system 104 may generate alerts that are specifically directed towards an administrator of academic institution, such as a principal. For example, alert 860 may notify an administrator of a teacher's deficiency in providing instruction for a particular standard or skill. The server system 104 may detect a decrease in learning velocity of an entire class, if a deficiency began when the class started studying a particular standard, skill, or other learning objective. The alert 860 may notify the administrator of who the teacher is, how much the learning velocities have decreased, and may specify what types of learning objective the teacher may need assistance with delivering. Alert 865 may notify the administrator when a particular teacher's class is behind schedule for a target learning objective or academic event, e.g., an academic event 63. Advantageously, these reports or alerts enable the server system 104 to provide objective feedback on the effectiveness of a teacher and/or provides tools for enabling teachers and parents to assist students who are struggling with one or more subjects in school.

FIG. 8B illustrates the learning velocity tab 820 that the server system 104 generates to enable a teacher, a parent, or other individual to track the progress of the particular student. In particular, the tab 820 may include a graph 875 and a graph 880. The graph 875 displays a student's learning velocity and a class average learning velocity to enable a teacher or other administrator to compare the student's progress with his or her peers. The graph 875 depicts a student's learning velocity with respect to time. The time axis may be represented in months, days, weeks, years, etc. In response to receiving alerts that a student, such as Joey, is struggling, a parent or teacher may look at the graph 875 to determine when the student started struggling and may look at events that occurred during that timeframe to attempt to discover the cause of the students decrease in performance. According one embodiment, the server system 104 may be configured to alert a teacher or parent if a student's learning velocity decreases by more than 10% from a maximum. In other embodiments, the server system 104 may be configured to alert a teacher or parent if a students learning velocity decreases by more than 10% over a period of time, such as a month. Other thresholds and timeframe may be set, according to other embodiments.

The graph 880 shows a student's learning velocity with respect to various standards or skills within a learning objective. The server system 104 may generate the graph 880 to enable teachers and parents to pinpoint the subjects, skills, or other learning objectives that a student appears to be struggling with. For example, the graph 880 shows, along the X-axis, several skills associated with a standard related to fractions. The skills may be displayed in the order that they were presented to the student. Initially, the X-axis shows that Joey had a learning velocity of 0.095 or greater while learning about adding fractions, subtracting fractions, least common denominators, writing algebraic expressions, and graphing ordered pairs. The graph 880 then shows that when Joey began studying skills related to a multi-digit division standard, Joey's learning velocity decreased by approximately 20%. In particular, Joey's learning velocity decreased while studying quotients for multiples, to digit divisors, and estimating quotients.

Although not shown, the learning velocity tab 820 may include additional features to enable a teacher, parent, or other administrator to keep track of the progress of individual students and evaluate the effectiveness of teachers. In some embodiments, the learning velocity tab 820 includes drop-down menus, or other inputs to enable a teacher or administrator to select a school, a classroom, or other students to view groups of learning velocities with respect to time or with respect to subject matter. In one embodiment, a parent having multiple children may use the learning velocity tab 820 to view graphs of his or her various children's progress over time and/or with respect to various subjects.

FIG. 8C illustrates the curriculum tab 825 that the server system 104 may generate to enable an administrator, a teacher, or a parent to assign or associate a target date with a learning objective in order to generate a target learning objective, i.e., an academic event. The curriculum tab 825 shows various standards, such as a multi-digit division standard 882, a fractions standard 884, a concept of area standard 886, and a reasoning and problem-solving standard 888. The curriculum tab 825 also illustrates various skills 890 that may be associated with one or more standards. Each standard may be represented as an expandable tree that may be used to display one or more skills or learning objectives that are associated with that standard. As illustrated, each of the standards, skills, or other learning objective may have a corresponding date box 892 into which a target date or range of dates may be entered. A submit button 894 and a cancel button 896 may be used to create the target learning objective or to cancel the date or dates entered into the date boxes 892. Although FIG. 8C depicts standards and skills, it will be appreciated that lessons may be presented by the system as well in the screen associated with the curriculum tab 825.

FIG. 8D illustrates the support tab 830 that the server system 104 may generate to enable a teacher to submit a supplemental instruction request. The support tab 830 may illustrate various drop-down menus such as student name menu 891, a subject menu 893, and a standards/skills menu 895. A teacher may use one or more of the drop-down menus 891, 893, and 895 to select a student for which the teacher has a particular concern. In response to receiving the teacher's request, the server system 104 may repeat or reevaluate a student in a learning objective or for a particular set of skills. The server system 104 may decrease the pace and provide additional interactive elements to assist the student's learning. In one embodiment, the server system 104 may attempt to diagnose learning disabilities, such as dyslexia, is a student. In other embodiments, rather than drop down menus, other graphical user inputs are provided to enable a teacher to submit requests to the developer or administrator of the administrative dashboard 800.

FIG. 9 shows an example of hardware 900 that may be used to implement the system 104. The hardware 900 typically includes at least one processor 1002 coupled to a memory 904. The processor 902 may represent one or more processors (e.g., microprocessors), and the memory 904 may represent random access memory (RAM) devices comprising a main storage of the hardware 900, as well as any supplemental levels of memory e.g., cache memories, non-volatile or back-up memories (e.g. programmable or flash memories), read-only memories, etc. In addition, the memory 904 may be considered to include memory storage physically located elsewhere in the hardware 900, e.g. any cache memory in the processor 902, as well as any storage capacity used as a virtual memory, e.g., as stored on a mass storage device 910.

The hardware 900 also typically receives a number of inputs and outputs for communicating information externally. For interface with a user or operator, the hardware 900 may include one or more user input devices 906 (e.g., a keyboard, a mouse, a scanner etc.) and a display 908 (e.g., a Liquid Crystal Display (LCD) panel). For additional storage, the hardware 900 may also include one or more mass storage devices 910, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 900 may include an interface with one or more networks 912 (e.g., a local area network (LAN), a wide area network (WAN), a wireless network, and/or the Internet among others) to permit the communication of information with other computers coupled to the networks. It should be appreciated that the hardware 900 typically includes suitable analog and/or digital interfaces between the processor 1002 and each of the components 904, 906, 908 and 912 as is well known in the art.

The hardware 900 operates under the control of an operating system 914, and executes various computer software applications, components, programs, objects, modules, etc. indicated collectively by reference numeral 916 to perform the techniques described above

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

I/We claim:

1. A computer-based method of delivering a sequence of learning objectives to a student in accordance with a received target date, the method comprising:
maintaining a plurality of learning objectives, each learning objective having a weight that represents a difficulty or quantity of individual skills within the learning objective, each learning objective having prior learning objectives and subsequent learning objectives connected together in a hierarchical relationship of parent nodes and children nodes;
establishing a target learning objective by associating the target date with at least one of the learning objectives;
determining which of the plurality of learning objectives are prerequisite to the target learning objective based on the hierarchical relationship between the target learning objective and the other learning objectives;
comparing learning objectives completed by the student to the prerequisite learning objectives to determine a remaining number of learning objectives for the student to complete in order to achieve the target learning objective;
summing the weights of the remaining number of learning objectives to determine a total skill weight for the student to acquire in order to being the target learning objective;
determining a rate of skill acquisition associated with the student per unit of time;
determining an estimated time of completion for the prerequisite learning objectives for the student based on the remaining number of learning objectives and the rate of skill acquisition;
estimating a training time for the student, the training time including an average time the student will spend studying the learning objectives between a present time and the target date;
comparing the estimated training time for the student to the estimated time of completion of the prerequisite learning objectives; and
if the estimated time of completion of prerequisite learning objectives is longer than the estimated training time for the student, notifying an administrator.

2. The method of claim 1, further comprising determining an optimal path between the learning objectives completed by the student and the target learning objective.

3. The method of claim 2, wherein the optimal path is a path having a fewest number of learning objectives between the learning objectives completed by the student and the target learning objective, the path not including all of the remaining number of learning objectives.

4. The method of claim 2, wherein the optimal path is a path having learning objectives with a lowest total weight for the student to acquire, the path being between the learning objectives completed by the student and the target learning objective, the path not including all of the remaining number of learning objectives.

5. The method of claim 1, wherein the one or more target dates is a single day scheduling the beginning of the target learning objective or a single day scheduling the completion of the target learning objective.

6. The method of claim 1, wherein the one or more target dates is a range of calendar dates defining a time frame within which the student is scheduled to work on the target learning objective.

7. The method of claim 1, wherein determining the rate of skill acquisition includes initially using an average rate of skill acquisition of students:
from the same classroom of the student,
from the same grade of the student at a same school,
from the same grade of the student in the same state of the student, or
from the same grade of the student in the same country of the student.

8. The method of claim 1, wherein determining the rate of skill acquisition includes generating the rate of skill acquisition based on academic grades received by the student.

9. The method of claim 1, further comprising periodically updating the rate of skill acquisition based on an assessment of interaction of the student with the learning objective.

10. The method of claim 9, wherein periodically updating the rate of skill acquisition includes updating the rate of skill acquisition upon completion of each skill, upon completion of each lesson, or upon completion of each standard.

11. The method of claim 9, wherein periodically updating the rate of skill acquisition includes updating the rate of skill acquisition based on a predetermined period of time.

12. The method of claim 1, further comprising updating values of the weights based on observed effort exerted by a group of students to complete the learning objectives, the values of the weights being updated periodically.

13. The method of claim 1, wherein the estimated training time is determined based on past performance of the student.

14. The method of claim 1, further comprising adjusted the estimated training time to account for holidays and vacation breaks from school.

15. The method of claim 1, wherein notifying an administrator includes identifying a portion of a learning objective on which the student performs poorly or a decrease of the rate of skill acquisition.

16. The method of claim 1, wherein notifying an administrator includes:
displaying a comparison of the rate of skill acquisition of the student with an average weight of skill of classmates of the student; and
displaying suggestions for remedial actions for a the administrator to take to assist the student in increasing the training time for the student or increasing the learning velocity of the student.

17. The method of claim 1, further comprising:
scheduling the student to receive additional lesson objectives other than prerequisite learning objectives if the estimated training time is greater than the estimated time of completion.

18. The method of claim 1, further comprising:
if the estimated training time is initially greater than the estimated time of completion, scheduling the student to receive fewer lesson objectives other than prerequisite learning objectives if the estimated training time approaches the estimated time of completion.

19. The method of claim 1, wherein the administrator is a parent or teacher of the student, the method further comprising:
receiving a supplemental instruction request from the parent or the teacher of the student via a user interface, the supplemental instruction request identifying the student and an academic area of concern; and
in response to the receiving the supplemental instruction request, providing supplemental lessons to the student that are associated with the academic area of concern and that are included in one or more of the learning objectives.

20. A non-transitory computer-readable medium having instructions which, when executed by a processor of a computing system, cause the computing system to execute a method of delivering a sequence of learning objectives to a student in accordance with a received target date, the method comprising:
maintaining a plurality of learning objectives, each learning objective having a weight that represents a difficulty or quantity of individual skills within the learning objective, each learning objective having prior learning objectives and subsequent learning objectives connected together in a hierarchical relationship of parent nodes and children nodes;
establishing a target learning objective by associating the target date with at least one of the learning objectives;
determining which of the plurality of learning objectives are prerequisite to the target learning objective based on the hierarchical relationship between the target learning objective and the other learning objectives;
comparing learning objectives completed by the student to the prerequisite learning objectives to determine a remaining number of learning objectives for the student to complete in order to achieve the target learning objective;
summing the weights of the remaining number of learning objectives to determine a total skill weight for the student to acquire in order to being the target learning objective;
determining a rate of skill acquisition associated with the student per unit of time;
determining an estimated time of completion for the prerequisite learning objectives for the student based on the remaining number of learning objectives and the rate of skill acquisition;
estimating a training time for the student, the training time including an average time the student will spend studying the learning objectives between a present time and the target date;
comparing the estimated training time for the student to the estimated time of completion of the prerequisite learning objectives; and
if the estimated time of completion of prerequisite learning objectives is longer than the estimated training time for the student, notifying an administrator.

21. The computer-readable medium of claim 20, further comprising instructions, that when executed by the processor, cause the computing system to further execute the method, comprising:
determining an optimal path between the learning objectives completed by the student and the target learning objective.

22. The computer-readable medium of claim 21, wherein the optimal path is a path having a fewest number of learning objectives between the learning objectives completed by the student and the target learning objective, the path not including all of the remaining number of learning objectives.

23. The computer-readable medium of claim 21, wherein the optimal path is a path having learning objectives with a lowest total weight for the student to acquire, the path being between the learning objectives completed by the student and the target learning objective, the path not including all of the remaining number of learning objectives.

24. The computer-readable medium of claim 20, wherein the one or more target dates is a single day scheduling the beginning of the target learning objective or a single day scheduling the completion of the target learning objective.

25. The computer-readable medium of claim 20, wherein determining the rate of skill acquisition includes initially using an average rate of skill acquisition of students:
from the same classroom of the student,
from the same grade of the student at a same school,
from the same grade of the student in the same state of the student, or
from the same grade of the student in the same country of the student.

26. The computer-readable medium of claim 20, further comprising instructions, that when executed by the processor, cause the computing system to further execute the method, comprising:
periodically updating the rate of skill acquisition based on an assessment of interaction of the student with the learning objective.

27. The computer-readable medium of claim 20, further comprising instructions, that when executed by the processor, cause the computing system to further execute the method, comprising:
updating values of the weights based on observed effort exerted by a group of students to complete the learning objectives, the values of the weights being updated periodically.

28. The computer-readable medium of claim 20, wherein notifying an administrator includes:
identifying a portion of a learning objective on which the student performs poorly or a decrease of the rate of skill acquisition; and
displaying suggestions for remedial actions for a the administrator to take to assist the student in increasing the training time for the student or increasing the learning velocity of the student.
